(19) United States
(12) Patent Application Publication
(10) Pub. No.: US 2026/0267089 A1
(43) Pub. Date: Sep. 10, 2026

(54) LIGHT SOURCE MODULE, OPTICAL ENGINE, IMAGE DISPLAY DEVICE, AND METHOD FOR MANUFACTURING LIGHT SOURCE MODULE

(71) Applicant: TDK Corporation, Tokyo (JP)

(72) Inventors: Takashi HONDA, Tokyo (JP); Taku SOMEYA, Tokyo (JP); Ryohei FUKUZAKI, Hong Kong (CN); Tsuyoshi KOMAKI, Tokyo (JP)

(73) Assignee: TDK Corporation, Tokyo (JP)

(21) Appl. No.: 19/540,043

(22) Filed: Feb. 13, 2026

(30) Foreign Application Priority Data
Mar. 7, 2025 (JP) 2025-036821

(51) Int. Cl. G02B 6/42; F21V 8/00; F21V 29/74; F21Y 115/10

(52) U.S. Cl. CPC G02B 6/4214; F21V 29/74; G02B 6/0068; G02B 6/4204; F21Y 2115/10

(57) ABSTRACT

This light source module includes a subcarrier, a plurality of laser light sources installed on an upper surface of the subcarrier, a heat dissipation member arranged near a lower surface of the subcarrier, an optical member substrate, and an optical waveguide arranged on a surface side of the optical member substrate. The subcarrier and the optical member substrate are arranged such that light output from the laser light sources is input to the optical waveguide, and are integrally coupled with a metal layer therebetween. The heat dissipation member and the optical member substrate are integrally coupled.

### BACKGROUND OF THE INVENTION

### Field of the Invention

The present invention relates to a light source module, an optical engine, an image display device, and a method for manufacturing a light source module.

The present application claims priority on Japanese Patent Application No. 2025-036821 filed on Mar. 7, 2025, the content of which is incorporated herein by reference.

### Description of Related Art

Optical element assemblies for XR glasses, such as augmented reality (AR) glasses and virtual reality (VR) glasses incorporating a plurality of laser diodes, are expected to serve as compact wearable devices. In wearable devices such as AR glasses and VR glasses, miniaturization such that all functions fit within an ordinary eyeglass form factor is the key to widespread adoption.

Patent Document 1 discloses an integrated optical device (light source module) in which a base mount (subcarrier) holding an optical semiconductor element (for example, a laser diode) and a substrate (optical member substrate) having an optical waveguide provided on a surface thereof are bonded with a metal layer therebetween in a state where a light emitting position of the optical semiconductor element and a position of the optical waveguide are accurately positioned, thereby achieving miniaturization.

In a configuration in which the base mount and the substrate are bonded with a metal layer therebetween, a bonding strength is improved as compared with a configuration bonded with an adhesive, and temperature dependence of the bonding strength is also curbed.

In an integrated optical device (light source module) using a substrate (optical member substrate) having a relatively high thermal conductivity such as a silicon substrate, heat generated in the optical semiconductor element is transmitted to the substrate via the base mount (subcarrier) so that the heat can be dissipated; and therefore, a light emission test and rated operation can be performed using the light source module alone.

### Patent Document

Patent Document 1 Japanese Patent No. 7514094

### SUMMARY OF THE INVENTION

However, in the case of a substrate made of glass, quartz glass manufactured by a melting method, or a similar material having a comparably low thermal conductivity, heat generated by a laser diode is transmitted to a subcarrier, but there is no heat dissipation path beyond that point. Consequently, defective light emission may occur, making it impossible to perform a light emission test or rated operation for a light source module.

In addition, even in the case of a substrate made of a material having a high thermal conductivity, such as a silicon substrate, when a light emission test is performed in a high-output region, defective light emission may occur due to self-heating.

The present invention has been made in consideration of the foregoing problems, and an object thereof is to provide a light source module which can be miniaturized and stably driven even in a high-output region while requiring substantially no optical axis alignment, an optical engine, an image display device, and a method for manufacturing a light source module.

In order to solve the foregoing problems, the present invention provides the following features.

According to Aspect 1 of the present disclosure, there is provided a light source module including a subcarrier, a plurality of laser light sources installed on an upper surface of the subcarrier, a heat dissipation member arranged near a lower surface of the subcarrier, an optical member substrate, and an optical waveguide arranged on a surface side of the optical member substrate. The subcarrier and the optical member substrate are arranged such that light output from the laser light sources is input to the optical waveguide, and are integrally coupled with a metal layer therebetween. The heat dissipation member and the optical member substrate are integrally coupled.

According to Aspect 2 of the present disclosure, in the light source module according to Aspect 1, the heat dissipation member is further arranged near a side surface of the subcarrier.

According to Aspect 3 of the present disclosure, in the light source module according to Aspect 2, a groove for subcarrier is formed on a surface of the heat dissipation member, and the subcarrier is arranged in the groove in a state where the lower surface and the side surface of the subcarrier are surrounded by inner surfaces of the groove.

According to Aspect 4 of the present disclosure, in the light source module according to any one of Aspects 1 to 3, the subcarrier is separately provided for each of the plurality of laser light sources, and the heat dissipation member is a common member shared by the separate subcarriers.

According to Aspect 5 of the present disclosure, in the light source module according to any one of Aspects 1 to 4, the subcarrier is made of aluminum nitride, aluminum oxide, or silicon.

According to Aspect 6 of the present disclosure, in the light source module according to any one of Aspects 1 to 5, the subcarrier and the optical member substrate are eutectically bonded with the metal layer therebetween.

According to Aspect 7 of the present disclosure, in the light source module according to any one of Aspects 1 to 6, the optical member substrate is made of any material selected from the group consisting of a metal material, a ceramic material, and a semiconductor material.

According to Aspect 8 of the present disclosure, in the light source module according to any one of Aspects 1 to 7, the heat dissipation member is made of a ceramic material or a metal material.

According to Aspect 9 of the present disclosure, in the light source module according to any one of Aspects 1 to 8, a gap between the heat dissipation member and the subcarrier is a gap of 50 μm or smaller, or is filled with a metal paste in a solidified state.

According to Aspect 10 of the present disclosure, in the light source module according to Aspect 9, the metal paste is a silver paste.

According to Aspect 11 of the present disclosure, in the light source module according to any one of Aspects 1 to 10, the heat dissipation member and the optical member substrate are bonded with an adhesion layer therebetween.

According to Aspect 12 of the present disclosure, in the light source module according to Aspect 11, the adhesion layer is made of a resin material or is made of a resin material and a filler, the resin material is a urethane resin or an epoxy resin, and the filler is silica, alumina, copper, or aluminum.

According to Aspect 13 of the present disclosure, in the light source module according to any one of Aspects 1 to 12, the heat dissipation member and the optical member substrate are individually attached to a common support plate, and the heat dissipation member and the optical member substrate are integrally coupled with the support plate therebetween.

According to Aspect 14 of the present disclosure, in the light source module according to any one of Aspects 1 to 13, all of the plurality of laser light sources are visible-light laser light sources outputting visible light rays.

According to Aspect 15 of the present disclosure, in the light source module according to Aspect 14, a plurality of the visible light rays are red light, green light, and blue light.

According to Aspect 16 of the present disclosure, there is provided an optical engine including the light source module according to Aspect 15, and an optical scanning mirror reflecting, while changing an angle thereof, light output from the light source module so as to display an image.

According to Aspect 17 of the present disclosure, there is provided an image display device including the optical engine according to Aspect 16 mounted thereon.

According to Aspect 18 of the present disclosure, the image display device according to Aspect 17 is XR glasses.

According to Aspect 19 of the present disclosure, there is provided a method for manufacturing the light source module according to any one of Aspects 1 to 15. The method includes a step of coupling the subcarrier and the plurality of laser light sources; a step of coupling, among the subcarrier and the plurality of laser light sources coupled to each other, the subcarrier and the optical member substrate with a metal layer therebetween; and a step of coupling the heat dissipation member and the optical member substrate such that a gap of a predetermined distance is provided between the heat dissipation member and the lower surface of the subcarrier.

According to Aspect 20 of the present disclosure, the method for manufacturing the light source module according to Aspect 19 further includes a step of filling the gap with a metal paste, and a step of solidifying the metal paste.

According to the light source module of the present disclosure, it is possible to provide a light source module which can be miniaturized and stably driven even in a high-output region while requiring substantially no optical axis alignment.

### BRIEF DESCRIPTION OF THE DRAWINGS

FIG. 1A is a partial schematic plan view of one embodiment of a light source module according to the present disclosure, showing a subcarrier viewed from a coupling (bonding) surface side of the subcarrier.

FIG. 1B is a view of the entire light source module shown in FIG. 1A viewed from a side, in which the subcarrier and an optical member substrate are coupled (bonded).

FIG. 1C is a schematic plan view of a configuration when a gap between the subcarrier and a heat dissipation member is a gap.

FIG. 2A is a partial schematic plan view of other embodiment of a light source module according to the present disclosure, showing the subcarrier viewed from the coupling (bonding) surface side.

FIG. 2B is a view of the entire light source module shown in FIG. 2A viewed from a side, in which the subcarrier and the optical member substrate are coupled (bonded).

FIG. 3A is an exploded schematic view showing a state where only the heat dissipation member is removed, in a schematic perspective view of the light source module shown in FIG. 3B.

FIG. 3B is a schematic perspective view of the light source module shown in FIGS. 1A and 1B.

FIG. 4 is a schematic perspective view of the light source module shown in FIGS. 2A and 2B.

FIG. 5 is a schematic plan view of still other embodiment of an entire light source module according to the present disclosure viewed from a side, in which the subcarrier and the optical member substrate are coupled (bonded).

FIG. 6 is a schematic plan view showing an example of the light source module according to the present disclosure, including a package.

FIG. 7 is a schematic plan view of further other embodiment of a light source module according to the present disclosure.

FIG. 8 is a schematic cross-sectional view taken along an XZ plane of a part of the light source module shown in FIG. 7, including a laser light source, depicting only a part of near a bonding portion.

FIG. 9 is an explanatory conceptual view of an example of XR glasses of the present disclosure.

FIG. 10 is a conceptual view showing a state where an image is directly projected onto a retina by laser light output from the light source module in the XR glasses shown in FIG. 9.

### DETAILED DESCRIPTION OF THE INVENTION

Hereinafter, the present disclosure will be described in detail with reference to the drawings as appropriate. In the drawings used in the following description, in order to facilitate understanding of the characteristics, characteristic parts may be shown in an enlarged manner for convenience, and dimensional ratios or the like of each constituent element may differ from actual values. Materials, dimensions, and the like exemplified in the following description are merely examples. The present disclosure is not limited thereto and can be suitably modified and carried out within a range in which the effects of the present disclosure are exhibited.

### Light source module

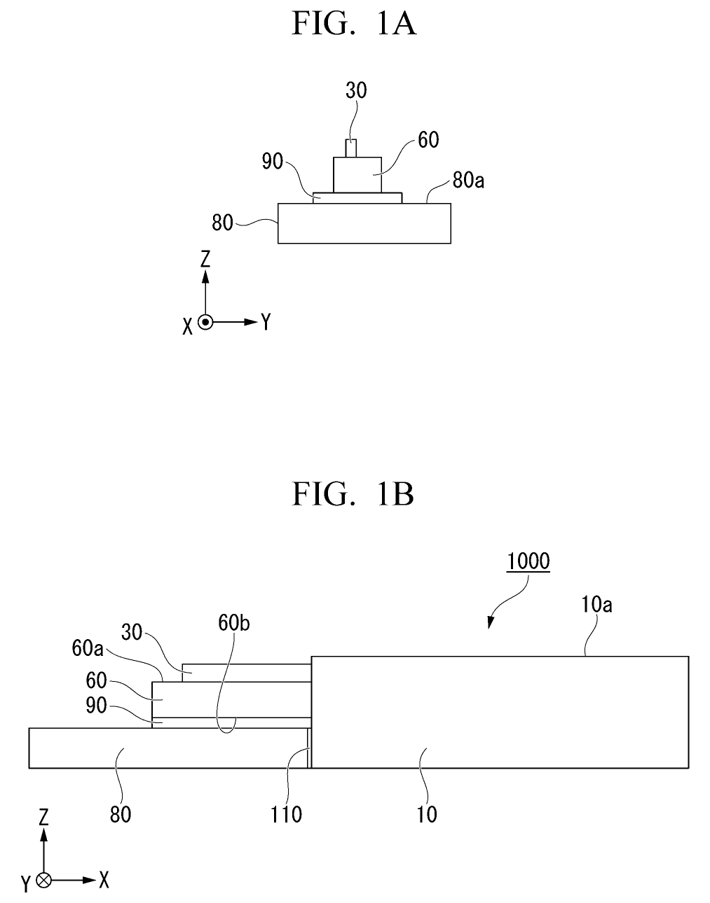

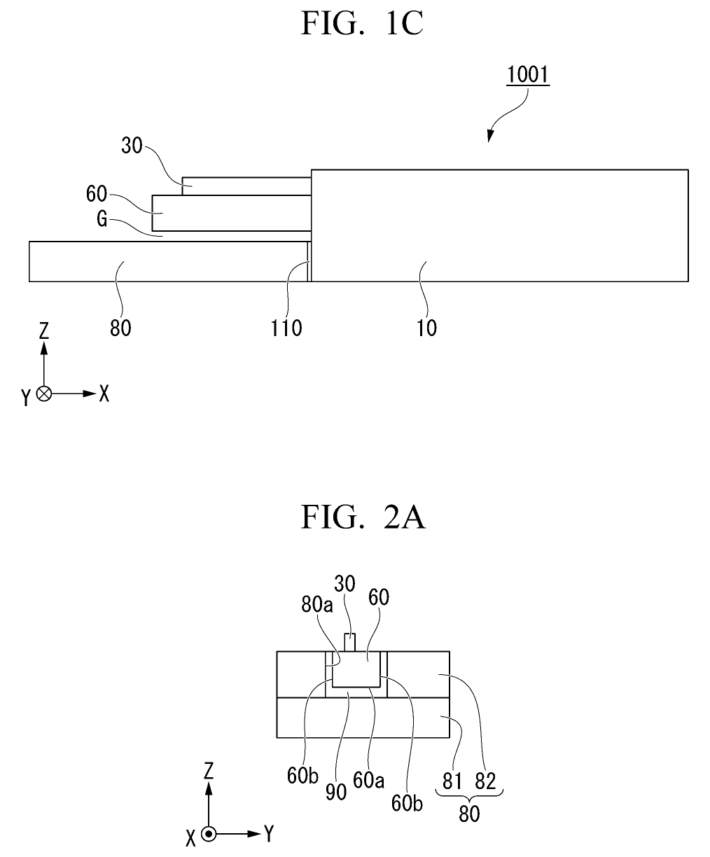

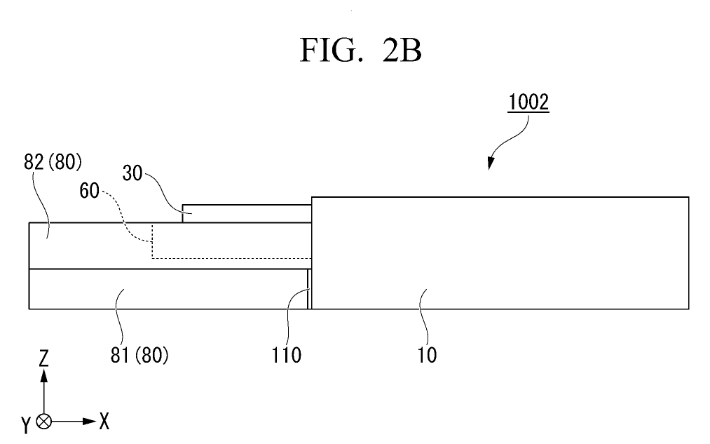

FIGS. 1A and 1B are partial schematic plan views of one embodiment of a light source module according to the present disclosure. FIG. 1A is a view of a subcarrier and a heat dissipation member viewed from a coupling (bonding) surface side of the subcarrier. FIG. 1B is a view of the entire light source module viewed from a side, in which the subcarrier and an optical member substrate are coupled (bonded). FIG. 1C is a schematic plan view of a configuration when a gap between the subcarrier and the heat dissipation member is a gap.

Here, in FIGS. 1A to 1C, an X direction is a direction in which the subcarrier and the optical member substrate are coupled and arranged, a Y direction is a direction orthogonal to the X direction, and a Z direction is a direction in which the subcarrier and the heat dissipation member are arranged. FIG. 1A is a schematic plan view of the subcarrier and the heat dissipation member viewed in a direction parallel to the X direction, and FIG. 1B is a schematic plan view of the light source module viewed in a direction parallel to the Y direction.

A light source module 1000 shown in FIG. 1B includes a subcarrier 60, a plurality of laser light sources 30 installed on an upper surface 60a of the subcarrier 60, a heat dissipation member 80 arranged near a lower surface 60b of the subcarrier 60, an optical member substrate 10, and optical waveguides arranged on a surface 10a side of the optical member substrate 10. The subcarrier 60 and the optical member substrate 10 are arranged such that light output from the laser light sources 30 is input to the optical waveguides, and the subcarrier 60 and the optical member substrate 10 are integrally coupled with a metal layer (not shown) therebetween. The heat dissipation member 80 and the optical member substrate 10 are integrally coupled with an adhesion layer 110 therebetween. In FIGS. 1B, 1C, 2B and 5, the thickness of the adhesion layer 110 is shown in an exaggerated manner.

Here, in this specification, “optical member substrate” refers to a substrate having optical waveguides on a surface side thereof. Having optical waveguides on a surface side of a substrate refers to a configuration in which optical waveguides are formed on a surface side inside a substrate, a configuration in which a layer having an optical waveguide is formed on a substrate, and the like.

In addition, when referring to being near a lower surface of a subcarrier, the term “near” refers to a distance from the lower surface approximately 0 μm to 50 μm. In addition, as shown in FIGS. 2A and 2B, when the heat dissipation member has a part near a side surface as well as a part near the lower surface, the term “near” also refers to a distance from the side surface approximately 0 μm to 50 μm.

In the light source module 1000 shown in FIGS. 1A and 1B, a gap G between the lower surface 60b of the subcarrier 60 and an upper surface 80a of the heat dissipation member 80 is filled with a metal paste in a solidified state, but it may be a gap (refer to FIG. 1C). In FIGS. 1A and 1B, the part in which the gap G is filled with a metal paste and solidified is indicated by the reference sign 90 in the drawings.

A light source module 1001 shown in FIG. 1C includes the subcarrier 60, a plurality of laser light sources 30 installed on the upper surface 60a of the subcarrier 60, the heat dissipation member 80 arranged near the lower surface 60b of the subcarrier 60, the optical member substrate 10, and optical waveguides arranged on the surface 10a side of the optical member substrate 10. The subcarrier 60 and the optical member substrate 10 are arranged such that light output from the laser light sources 30 is input to the optical waveguides, and the subcarrier 60 and the optical member substrate 10 are integrally coupled with a metal layer (not shown) therebetween. The heat dissipation member 80 and the optical member substrate 10 are integrally coupled with the adhesion layer 110 therebetween. The light source module 1001 shown in FIG. 1C is common with the light source module 1000 shown in FIGS. 1A and 1B in this respect, but differs in that the gap G between the lower surface 60b of the subcarrier 60 and the upper surface 80a of the heat dissipation member 80 is a gap.

### Laser light source

Various laser elements can be used as the laser light sources 30. The laser light sources 30 can emit visible light. In this case, the light source module 1000 is a visible-light light source module.

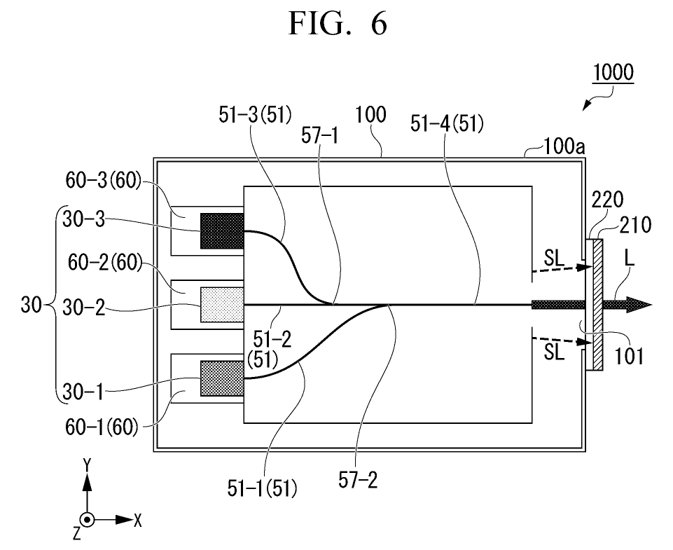

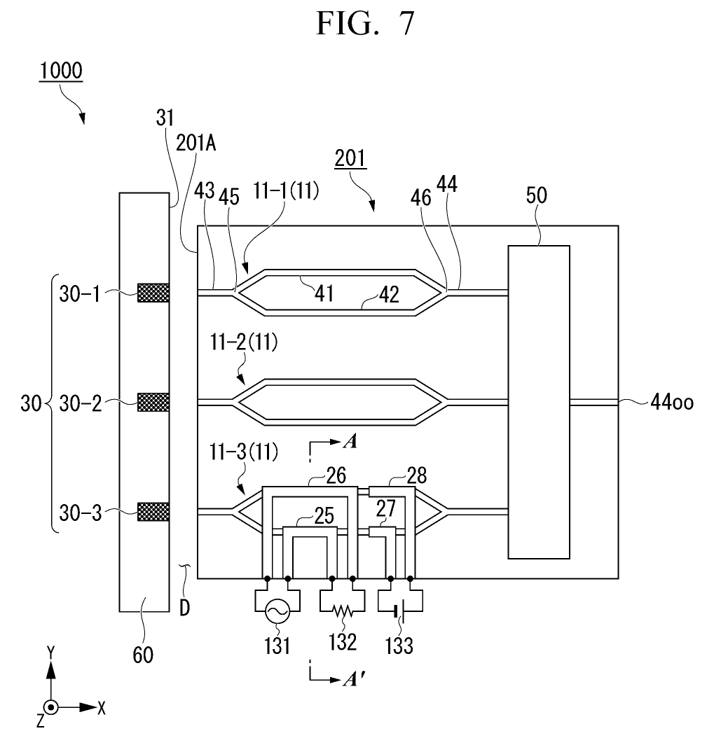

The plurality of laser light sources 30 can be three laser light sources 30-1, 30-2, and 30-3 (refer to FIGS. 6 and 7). In this case, for example commercially available laser diodes (LDs) emitting red light, green light, blue light, and the like can be used as the laser light sources 30. Light having a peak wavelength of 610 nm to 750 nm can be used as the red light, light having a peak wavelength of 500 nm to 560 nm can be used as the green light, and light having a peak wavelength of 435 nm to 480 nm can be used as the blue light.

The number of the plurality of laser light sources 30 may be other than three.

For example, the plurality of laser light sources 30 may be mounted on the subcarrier in a bare-chip (unpackaged chips) state.

The laser light sources 30 may be mounted on the subcarrier 60 with a metal layer therebetween. As for a method for forming the metal layer, a known method can be utilized without any particular limitations, and a known technique such as sputtering, vapor deposition, or application of a metal paste can be utilized. For example, the metal layer may contain one or a plurality of metals selected from the group consisting of gold (Au), platinum (Pt), silver (Ag), lead (Pb), indium (In), nickel (Ni), titanium (Ti), tantalum (Ta), tungsten (W), an alloy of gold (Au) and tin (Sn), a tin (Sn)-silver (Ag)-copper (Cu)-based solder alloy (SAC), SnCu, InBi, SnPdAg, SnBiIn, and PbBiIn, or may consist of one or a plurality of kinds of metals selected from this group.

The subcarrier 60 and the optical member substrate 10 are positioned such that the output ports of the laser light sources 30 face the input ports of the optical waveguides provided in the optical member substrate 10, and the laser light output from the output port of each laser light source 30 can be input to the input port of each optical waveguide, whereby each laser light source 30 and each optical waveguide are optically connected.

By adopting a configuration in which the subcarrier 60 is directly bonded to the substrate 10 with a metal layer (not shown) therebetween, miniaturization can be achieved by eliminating spatial coupling or fiber coupling.

In FIGS. 1B, 1C, 2B, 5 and 6, the output surfaces of the laser light sources 30 are in contact with the input surface of the optical member substrate 10, but the output surfaces of the laser light sources 30 and the input surface of the optical member substrate 10 may be arranged to have a gap of a predetermined distance (reference sign D in FIG. 7). Since the light source module 1000 is exposed to air, the gap is filled with air. Since the gap D is in a state of being filled with the same gas (air), it is easy to input each color light output from the laser light sources 30 to an input path in a state where predetermined coupling efficiency has been satisfied. When the visible-light light source module 1000 is used for AR glasses or VR glasses, considering the light amount and the like required for AR glasses and VR glasses, the size of the gap (distance) in the x direction is preferably greater than 0 μm and 5 μm or smaller, for example.

### Subcarrier

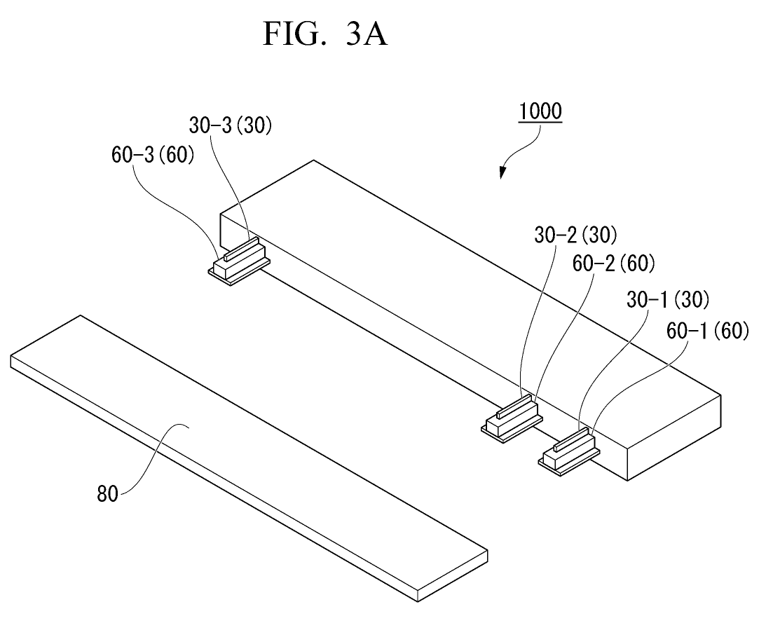

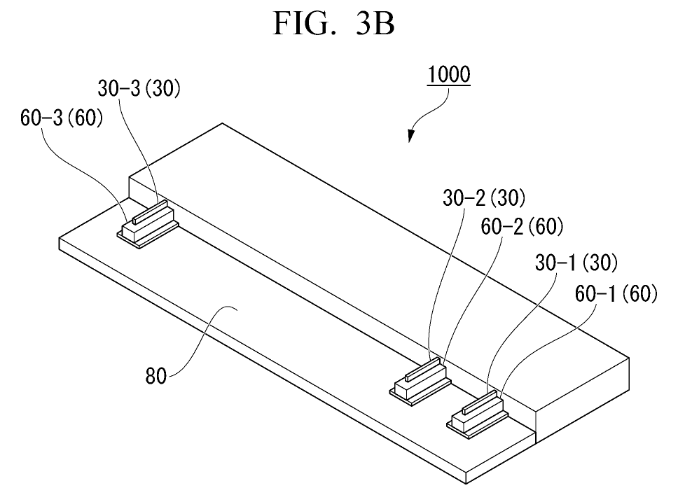

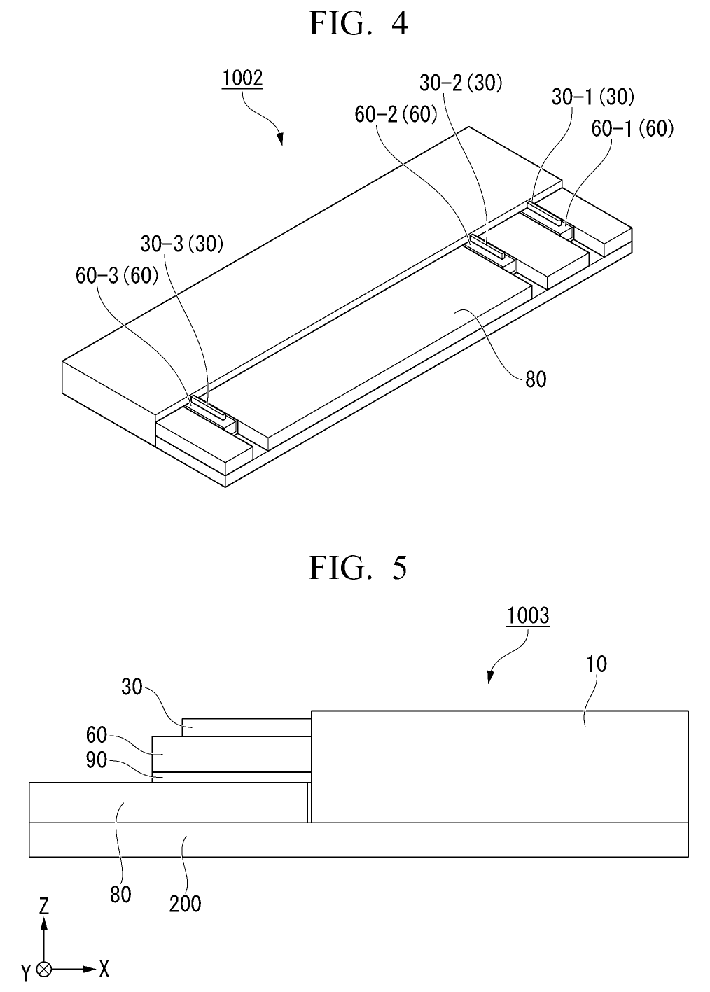

The subcarrier 60 may be a member provided separately for each of a plurality of laser light sources (refer to FIGS. 3B and 4), or may be a common member shared by a plurality of laser light sources (refer to FIG. 7).

Examples of materials of the subcarrier 60 include aluminum nitride (AlN), aluminum oxide (Al₂O₃), and silicon (Si).

### Optical member substrate

As for the optical member substrate 10, a substrate made of any material selected from the group consisting of a metal material, a ceramic material, and a semiconductor material can be used. Examples thereof include a silicon substrate, a sapphire substrate, a glass material (for example, quartz) substrate, and a thermally oxidized silicon substrate.

For example, the optical member substrate 10 can be a silicon substrate, and an optical waveguide layer having optical waveguides on a surface side of the silicon substrate can be made of a glass material (for example, quartz). This optical waveguide layer is a layer referred to as a planar lightwave circuit (PLC). This quartz-based PLC is an optical circuit made of quartz glass which is the same material as optical fibers.

The optical waveguides are cores, and cladding is arranged around them. The refractive index of the cores is higher than the refractive index of the cladding by a predetermined value. Accordingly, light input to each core is propagated through each core while being totally reflected at an interface between each core and the cladding. For example, the cores are doped with impurities such as germanium (Ge).

The optical waveguide layer (PLC) will be described using FIG. 6. FIG. 6 is a schematic plan view showing an example of the light source module, depicted to include a package 100 accommodating the light source module 1000 therein.

First, the light source module 1000 shown in FIG. 6 will be described. A light-transmitting window 101 allowing laser light L output from the laser light sources 30 to be optically transmitted therethrough is formed in a wall portion (side wall portion) 100a arranged in a direction in which laser light is output in the package 100.

In the side wall portion 100a, a light-transmitting window (opening) 101 is formed in the side wall portion 100a in the vicinity of an output portion of the laser light L output from the laser light sources 30 via the optical waveguide layer. The opening 101 is formed with its center substantially at the point where the optical axis of laser light output in the side wall portion 100a intersects. The opening 101 is covered without a gap therebetween by a glass plate 220 from outside the side wall portion 100a. An accommodation portion accommodating a main body portion of the light source module is hermetically sealed by the glass plate 220 in addition to the cover (not shown). Although the glass plate 220 is used for hermetic sealing, the material is not limited to a glass plate as long as laser light can be transmitted through. Anti-reflection films (not shown) may be provided on both plate surfaces of the glass plate 220.

In the light source module 1000 shown in FIG. 6, the laser light L from the laser light sources 30 is propagated through the optical waveguide layer, and passes through the light-transmitting window (opening) 101, the glass plate 220, and an output light aperture 200 in this order, and is output.

In FIG. 6, the dotted arrow indicated by the reference sign SL shows a part of stray light, and the output light aperture 200 blocks leakage of stray light to outside of the laser module 1000.

The PLC is provided with cores 51-1, 51-2, and 51-3 corresponding in number to the laser light sources 30-1, 30-2, and 30-3, and a cladding (not shown) surrounding the cores 51-1, 51-2, and 51-3. The thickness of the cladding (not shown) and the widthwise dimensions of the cores 51-1, 51-2, and 51-3 are not particularly limited. For example, the cores 51-1, 51-2, and 51-3 having widthwise dimensions of several micrometers are arranged in the cladding (not shown) having a thickness of approximately 50 μm.

As shown in FIG. 6, the cores 51-1, 51-2, and 51-3 are gathered into one before reaching the output surface of the PLC. That is, the cores 51-1, 51-2, and 51-3 sequentially merge as they extend forward in the x direction and merge into a single core 51-4. In order to prevent leakage light from the cores 51-1, 51-2, and 51-3, it is preferable that each of the cores 51-1, 51-2, and 51-3 be connected to the core 51-4 with a radius of curvature equal to or greater than a predetermined radius of curvature.

By metal bonding between the optical member substrate 10 and the subcarrier 60, in a state where optical axes are accurately aligned such that the centers of the input ports of the respective cores 51-1, 51-2, and 51-3 in the PLC substantially coincide with the optical axes of output light from the corresponding laser light sources 30-1, 30-2, and 30-3, each core and each corresponding laser light source are arranged so as to face each other.

As shown in FIG. 6, red light, green light, and blue light emitted from the laser light sources 30-1, 30-2, and 30-3 are respectively input to the cores 51-1, 51-2, and 51-3, and then are propagated through the respective cores. Blue light and green light propagated through the cores 51-3 and 51-2 are coupled at a predetermined merging position 57-1 located rearward in the x direction from a merging position 57-2. The coupled blue light and green light are combined with red light propagated through the core 51-1 at the merging position 57-2. The RGB light which has been coupled at the merging position 57-2 is propagated through the core 51-4, reaches the output surface, and is output from the output surface.

### Bonding between subcarrier and optical member substrate

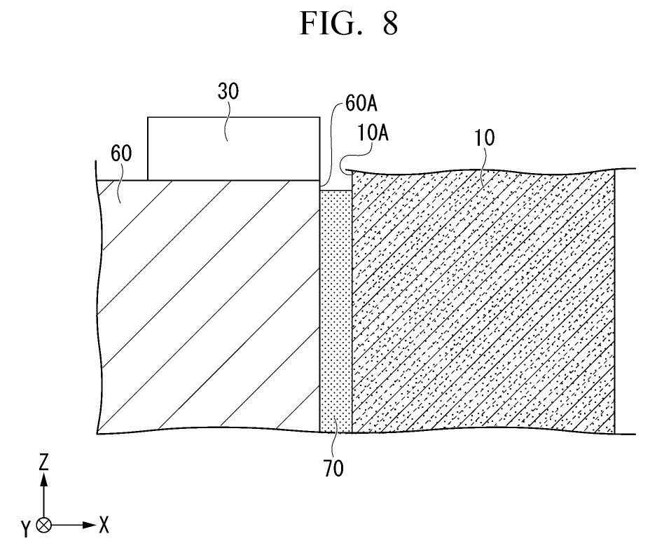

The subcarrier 60 and the optical member substrate 10 are arranged such that the light output from the laser light sources 30 is input to the optical waveguides, and are integrally coupled (metal-bonded) with a metal layer (reference sign 70 in FIG. 8) therebetween.

By this metal bonding, accurate optical axis arrangement can be achieved, and miniaturization is realized.

The metal layer 70 may be a metal laminated film composed of a plurality of metal films. For example, the metal layer 70 can be a metal laminated film composed of a three-layer metal film (a first metal layer, a third metal layer, and a second metal layer).

Hereinafter, a configuration will be described as an example in which a side surface 60A of the subcarrier 60 facing the substrate 10 and a side surface 10A of the substrate 10 facing the subcarrier 60 are connected by the metal laminated film therebetween, and the metal laminated film is composed of the first metal layer, the third metal layer, and the second metal layer arranged in this order from the side surface 60A side. Contrary to this configuration, a configuration may be adopted in which they are connected by the metal laminated film therebetween, and the metal laminated film is composed of the first metal layer, the third metal layer, and the second metal layer arranged in this order from the side surface 10A.

The first metal layer is formed on the side surface 60A by sputtering, vapor deposition, or the like, and may include, for example, one or a plurality of metals selected from the group consisting of gold (Au), platinum (Pt), silver (Ag), lead (Pb), indium (In), nickel (Ni), titanium (Ti), and tantalum (Ta), or may consist of one or a plurality of metals selected from this group. The second metal layer is formed on the side surface 10A by sputtering, vapor deposition, or the like, and may include, for example, one or a plurality of metals selected from the group consisting of titanium (Ti), tantalum (Ta), nickel (Ni), tungsten (W), Ta/Pt, Ti/Pt, and Ni/Pt, or may consist of one or a plurality of metals selected from this group. The third metal layer is interposed between the first metal layer and the second metal layer, and may include, for example, one or a plurality of metals selected from the group consisting of aluminum (Al), copper (Cu), AuSn, SnCu, InBi, SnAgCu, SnPdAg, SnBiIn, and PbBiIn, or may consist of one or a plurality of metals selected from this group. For example, AuSn, SnAgCu, or SnBiIn can be used for the third metal layer.

Metal bonding is preferably realized by eutectic bonding. Preferable examples of eutectic coupling include Au-Sn bonding. As for the materials of the first metal layer and the third metal layer, a combination that forms Au-Sn bonding during bonding is preferable.

The thickness of the first metal layer, that is, the size of the first metal layer in the X direction is 0.01 μm to 5.00 μm, for example. The thickness of the second metal layer, that is, the size of the second metal layer in the X direction is 0.01 μm to 1.00 μm, for example. The thickness of the third metal layer, that is, the size in the X direction is 0.01 μm to 5.00 μm, for example. In addition, the thickness of the third metal layer is preferably greater than the thickness of each of the first metal layer and the second metal layer. With such a configuration, the respective roles of the first metal layer, the second metal layer, and the third metal layer described above are satisfactorily exhibited, and penetration of the material of the first metal layer into the substrate 10 and degradation in adhesion strength between the metal layers are curbed. The thicknesses of the first metal layer, the second metal layer and the third metal layer can be measured by spectroscopic ellipsometry, for example.

When the second metal layer is made of a metal selected from the group consisting of Ta, Ti, Ni, Ta/Pt, Ti/Pt, and Ni/Pt, and has a thickness of 0.1 μm or larger, it functions as a spacer. That is, by having a thickness of 0.1 μm or larger, a sufficient distance between the subcarrier 60 and the optical member substrate 10 can be secured. By securing a distance that allows formation of a space (gap) to the extent that the condition can be maintained that the volume of the space (gap) between the subcarrier 60 and the optical member substrate 10 is larger than the volume of the first metal layer and the third metal layer that melt during bonding, the first metal layer and the third metal layer can be retained within this space (gap). In this case, the thickness of the second metal layer is more preferably 0.2 μm or larger. In this case, from the viewpoint of material cost, it is preferable that the upper limit of the thickness of the second metal layer be approximately 0.4 μm.

### Heat dissipation member

The heat dissipation member 80 shown in FIGS. 1A to 1C is arranged near the lower surface 60b of the subcarrier 60.

From the viewpoint of heat dissipation, the heat dissipation member 80 is preferably closer to the lower surface 60b of the subcarrier 60, but from the viewpoint of manufacturing yield, it is preferable that the heat dissipation member 80 be spaced apart to some extent.

From these viewpoints, the gap G between the heat dissipation member 80 and the subcarrier 60 can be set to approximately 50 μm or smaller.

As described above, the gap G between the heat dissipation member 80 and the subcarrier 60 may be a gap, or may be in a state of being filled with a metal paste in a solidified state (reference sign 90). As the metal paste, silver (Ag) paste, which is a metal having high thermal conductivity, can be exemplified. Examples of metals having high thermal conductivity include, in descending order, silver (Ag), copper (Cu), gold (Au), and aluminum (Al).

When the gap G is filled with a fluid having relatively good thermal conductivity such as a silver (Ag) paste, solidification processing is performed after assembly. Although it depends on the design and selection, an ordinary silver (Ag) paste (thermal conductivity: 3 to 16 W/m·K) is used as the embedded paste material, or a silver (Ag)-based sintering paste material is used as the embedded paste material in the case of an assembly having sufficient heat resistance to allow sintering (sintered bonding). In the case of a sintering-based paste material, since the solidification temperature exceeds 200°C, selection of surrounding materials becomes important.

A member made of a ceramic material or a metal material can be used as the heat dissipation member 80. Examples of ceramic materials include aluminum nitride (AlN) and silicon carbide (SiC). Examples of metal materials include copper (Cu) and aluminum (Al).

The heat dissipation member 80 may be made of a ceramic material, and an outer surface thereof may be surface-treated with a metal having high a thermal conductivity such as copper (Cu) or aluminum (Al).

### Bonding between heat dissipation member and optical member substrate

The heat dissipation member 80 and the optical member substrate 10 are integrally coupled (bonded).

In the examples shown in FIGS. 1A to 1C, the heat dissipation member 80 and the optical member substrate 10 are bonded with the adhesion layer 110 therebetween.

A layer made of a resin material, or a layer made of a resin material mixed with a filler can be used as the adhesion layer 110, but the adhesion layer 110 is not limited thereto. Examples of the resin material include urethane resin and epoxy resin, and examples of the filler include silica, alumina, copper, and aluminum.

By adjusting a ratio between the resin material and the filler, the thermal conductivity of the adhesion layer 110 can be adjusted.

FIGS. 2A and 2B are schematic plan view of other embodiment of a light source module according to the present disclosure. FIG. 2A is a view of the subcarrier and the heat dissipation member viewed from the coupling (bonding) surface side of the subcarrier, and FIG. 2B is a view of the entire structure, in which the subcarrier and the optical member substrate are coupled (bonded), viewed from a side.

The light source module shown in FIGS. 2A and 2B differs from the light source modules shown in FIGS. 1A to 1C in that the heat dissipation member has not only a part facing the lower surface of the subcarrier but also a part facing the side surface of the subcarrier.

A light source module 1002 shown in FIG. 2B includes the subcarrier 60, a plurality of laser light sources 30 installed on the upper surface of the subcarrier 60, the heat dissipation member 80 arranged near the lower surface 60a of the subcarrier 60, the optical member substrate 10, and the optical waveguide arranged on the surface 10a side of the optical member substrate 10. The subcarrier 60 and the optical member substrate 10 are arranged such that light output from the laser light sources 30 is input to the optical waveguide, and the subcarrier 60 and the optical member substrate 10 are integrally coupled with a metal layer (not shown) therebetween. The heat dissipation member 80 and the optical member substrate 10 are integrally coupled with the adhesion layer 110 therebetween. The heat dissipation member 80 includes a part 81 arranged near the lower surface 60a of subcarrier 60, and parts 82 arranged near both side surfaces 60b of the subcarrier 60.

In the light source module 1002 shown in FIG. 2B, the parts 82 of the heat dissipation member 80 are provided on respective side surface sides of both side surfaces 60b of the subcarrier 60, but a configuration may be adopted in which the part 82 is provided only on one side surface side of both side surfaces 60b of the subcarrier 60.

FIG. 3B is a schematic perspective view of the light source module shown in FIGS. 1A and 1B. FIG. 3A is an exploded schematic view showing a state where only the heat dissipation member is removed in the schematic perspective view of the light source module shown in FIG. 3B.

As shown in FIG. 3B, in the light source module 1000, the subcarriers 60 (60-1, 60-2, 60-3) are separately provided for the three respective laser light sources 30-1, 30-2, and 30-3, and the heat dissipation member 80 is a common member shared by the separate subcarriers 60-1, 60-2, and 60-3.

By using the heat dissipation member 80 as a common member shared by the separate subcarriers 60-1, 60-2, and 60-3, as compared with a configuration in which the heat dissipation member is attached to each of the subcarriers 60-1, 60-2, and 60-3, the total volume of the heat dissipation member 80 can be increased so as to increase heat capacity so that the heat dissipation speed can be improved. However, the present disclosure does not exclude a configuration in which the heat dissipation member 80 is attached to each of the subcarriers 60-1, 60-2, and 60-3.

FIG. 4 is a schematic perspective view of the light source module shown in FIGS. 2A and 2B.

As shown in FIG. 4, in the light source module 1002 as well, the subcarriers 60 (60-1, 60-2, 60-3) are separately provided for the three respective laser light sources 30-1, 30-2, and 30-3, and the heat dissipation member 80 is a common member shared by the separate subcarriers 60-1, 60-2, and 60-3.

A groove for subcarrier 80a is formed on a surface of the heat dissipation member 80 provided in the light source module 1002 shown in FIG. 4, and the subcarrier 60 is arranged inside the groove 80a in a state where the lower surface 60a and both side surfaces 60b of subcarrier 60 are surrounded by the inner surfaces of the groove 80a.

As shown in FIG. 4, the heat dissipation member 80 is configured to have a shape having the gap G between the subcarrier 60 having the laser light sources 30 mounted thereon, and the heat dissipation member 80, in a state where the heat dissipation member 80 is attached to the optical member substrate 10.

FIG. 5 is a schematic plan view of still other embodiment of an entire light source module according to the present disclosure viewed from a side, in which the subcarrier and the optical member substrate are coupled (bonded).

A light source module 1003 shown in FIG. 5 has a configuration in which the heat dissipation member and the optical member substrate are individually attached to a common support plate 200, whereby the heat dissipation member and the optical member substrate are integrally coupled with the support plate 200.

As for a method for attaching the heat dissipation member and the optical member substrate to the common support plate 200, for example, the same material as that of the adhesion layer 110 described above can be used.

As described above, the light source module of the present disclosure has a configuration integrated with the optical member substrate having, on a surface side thereof, a laser light source, a carrier, a heat dissipation member (heat sink), and optical members (including at least optical waveguides and further including members necessary for guiding, combining (coupling), and emitting a plurality of laser lights, such as an optical combining portion (multimode interference type optical combining portion, Y-branch type optical combining portion, directional coupler, and the like)), such that sufficient heat dissipation characteristics can be maintained by forming heat conduction paths on a back surface of the carrier on which the laser light source is mounted, or on the back surface and side surfaces thereof. Accordingly, heat dissipation characteristics of the light source module itself before being housed in a package are improved, and light emission by the light source module alone before being housed in a package is enabled. Therefore, light emission testing and rated operation of the light source module alone before being housed in a package are enabled.

FIG. 6 is a schematic plan view including the package 100 in which the light source module 1000 shown in FIGS. 1A and 1B is accommodated. Similarly, each of the light source modules 1001, 1002, and 1003 may be provided with the package 100 in which the light source module is accommodated.

The package 100 is provided with a base (not shown) for installing the light source module at a predetermined position of an accommodation portion thereof. The light source module is provided on the base. In this case, it is preferable that the light source module be integrally coupled such that a bottom surface of the heat dissipation member 80 (heat dissipation member bottom surface) and a bottom surface of the substrate 10 (substrate bottom surface) are positioned on substantially the same plane S.

The bottom surface of the heat dissipation member 80 (heat dissipation member bottom surface) and the bottom surface of the substrate 10 (substrate bottom surface) can be bonded to an upper surface of the base mount via an adhesion layer. In order to enhance thermal conductivity, this adhesion layer can be made of a material in which a filler is mixed with a resin. Examples of resins constituting the adhesion layer include epoxy resin. Examples of fillers for improving thermal conductivity of the resin include copper powder, aluminum powder, and alumina powder.

By bonding the entire light source module to the upper surface of the base mount of the package 100 in this manner, heat generated by operation of the laser light sources 30 can be efficiently dissipated toward the base mount from both the bottom surface of the heat dissipation member 80 (heat dissipation member bottom surface) and the bottom surface of the substrate 10 (substrate bottom surface).

FIG. 7 is a schematic plan view of still other embodiment of the light source module according to the present disclosure. The light source module shown in FIG. 7 is a case in which, on the optical member substrate, a waveguide layer having a Mach-Zehnder-type optical waveguide having an optical modulation function is formed, and an optical waveguide included in the waveguide layer is made of a lithium niobate film (LiNbO₃). In FIG. 7, illustration of the heat dissipation member is omitted.

The waveguide layer in this case may be referred to below as an LN-based PLC. A known configuration can be used as the LN-based PLC.

The light source module shown in FIG. 7 includes, in the LN-based PLC provided on the optical member substrate 10, an optical modulator 201 including three Mach-Zehnder-type optical waveguides 11.

The optical modulator 201 shown in FIG. 7 includes three Mach-Zehnder-type optical waveguides 11-1, 11-2, and 11-3. However, three is merely an example, and two or four or more may be included. Each Mach-Zehnder-type optical waveguide 11 branches one input waveguide (optical waveguide) 43 into two ridge-type optical waveguides, a first ridge-type optical waveguide 41 and a second ridge-type optical waveguide 42, at a Y-branch portion 45, and the two ridge-type optical waveguides are combined again into one output waveguide 44 at a Y-branch portion 46.

In the optical modulator 201 shown in FIG. 7, light input from respective input ports of the three Mach-Zehnder-type optical waveguides 11-1,11-2, and 11-3 is modulated in the respective Mach-Zehnder-type optical waveguides, combined (coupled) by an optical combining portion 50, and output from a single output port 44oo.

The electrode configuration and circuit diagram shown in FIG. 7 are merely examples, and depict a case in which a DC bias voltage is superimposed on a high-frequency signal applied to electrodes 25 and 26.

The electrodes 25 and 26 are electrodes for applying a modulation voltage to each of the Mach-Zehnder-type optical waveguides 11-1, 11-2, and 11-3. The electrode 25 is an example of a first electrode, and the electrode 26 is an example of a second electrode. A power supply 131 is part of a high-frequency signal pulse generation control circuit that applies a modulation voltage to each Mac-Zehnder-type optical waveguide 11. A power supply 133 is part of a DC bias control circuit that applies a DC bias voltage to each Mach-Zehnder-type optical waveguide 11. For simplification of the drawing, the electrodes 25 and 26 are depicted only at a portion corresponding to the Mach-Zehnder-type optical waveguide 11-3.

As for the optical combining portion 50, for example, an MMI (multimode interference)-type optical coupler can be used.

In this configuration, the optical member substrate 10 is not particularly limited as long as it has a lower refractive index than the lithium niobate film. However, it is preferable to use a sapphire single-crystal substrate or a silicon single-crystal substrate as a substrate on which a single-crystal lithium niobate film can be formed as an epitaxial film. A crystal orientation of the single-crystal substrate is not particularly limited. For example, since a c-axis-oriented lithium niobate film has threefold symmetry, it is desirable that the single-crystal substrate (base) also have the same symmetry. Therefore, a c-plane substrate is preferable in the case of a sapphire single-crystal substrate, and a (111)-plane substrate is preferable in the case of a silicon single-crystal substrate.

For example, the lithium niobate film is a c-axis-oriented lithium niobate film. For example, the lithium niobate film is an epitaxial film epitaxially grown on the optical member substrate 10. An epitaxial film is a single-crystal film whose crystal orientation is aligned by a base substrate. The epitaxial film is a film having a single crystal orientation in the z direction and an in-plane xy direction, and the crystal is oriented with alignment in all of x-axis, y-axis, and z-axis directions. Whether the film formed on the optical member substrate 10 is an epitaxial film or not can be proven by, for example, checking the peak intensity and the pole at the orientation position in 2θ-θ X-ray diffraction.

The lithium niobate film can be an X-cut film.

The composition of lithium niobate is LiₓNbA_{y}O_{z}. In the formula, A is an element other than Li, Nb, and O. In the formula, x is 0.5 to 1.2 and is preferably 0.9 to 1.05. In the formula, y is 0 to 0.5. In the formula, z is 1.5 to 4.0 and is preferably 2.5 to 3.5. For example, the element A is K, Na, Rb, Cs, Be, Mg, Ca, Sr, Ba, Ti, Zr, Hf, V, Cr, Mo, W, Fe, Co, Ni, Zn, Sc, or Ce, and two or more kinds of these elements may be combined.

Moreover, the lithium niobate film may be a lithium niobate single-crystal thin film bonded onto the substrate.

The thickness of the lithium niobate film is 2 μm or smaller, for example. The thickness of the lithium niobate film refers to the thickness of portions other than ridge portions. If the thickness of the lithium niobate film is large, crystallinity may deteriorate.

In addition, for example, the thickness of the lithium niobate film is approximately 1/10 or more of a wavelength of light used. If the thickness of the lithium niobate film is small, optical confinement becomes weak, and light leaks into the substrate or the waveguide cladding film.

### Method for manufacturing light source module

A method for manufacturing a light source module of the present disclosure is a method for manufacturing the light source module according to foregoing the embodiment. The method includes: a step of coupling the subcarrier 60 and the plurality of laser light sources 30; a step of coupling, among the subcarrier 60 and the plurality of laser light sources 30 coupled to each other, the subcarrier 60 and the optical member substrate 10 with a metal layer therebetween; and a step of coupling the heat dissipation member 80 and the optical member substrate 10 such that a gap of a predetermined distance is provided between the heat dissipation member 80 and the lower surface 60b of the subcarrier 60.

The method for manufacturing a light source module of the present disclosure may further include a step of filling the gap G with a metal paste, and a step of solidifying the metal paste.

### Optical engine and XR glasses

In this specification, an optical engine is a device including a plurality of light sources, an optical system including a coupling portion coupling a plurality of light rays output from the plurality of light sources into a single light ray, an optical scanning mirror reflecting, while changing an angle thereof, light output from the optical system so as to display an image, and a control element controlling the optical scanning mirror.

The optical engine of the present disclosure includes a light source module according to the present disclosure, and an optical scanning mirror reflecting, while changing an angle thereof, light output from the light source module so as to display an image.

Hereinafter, an image display device including the optical engine of the present disclosure will be described as an example. XR glasses are an example of the image display device.

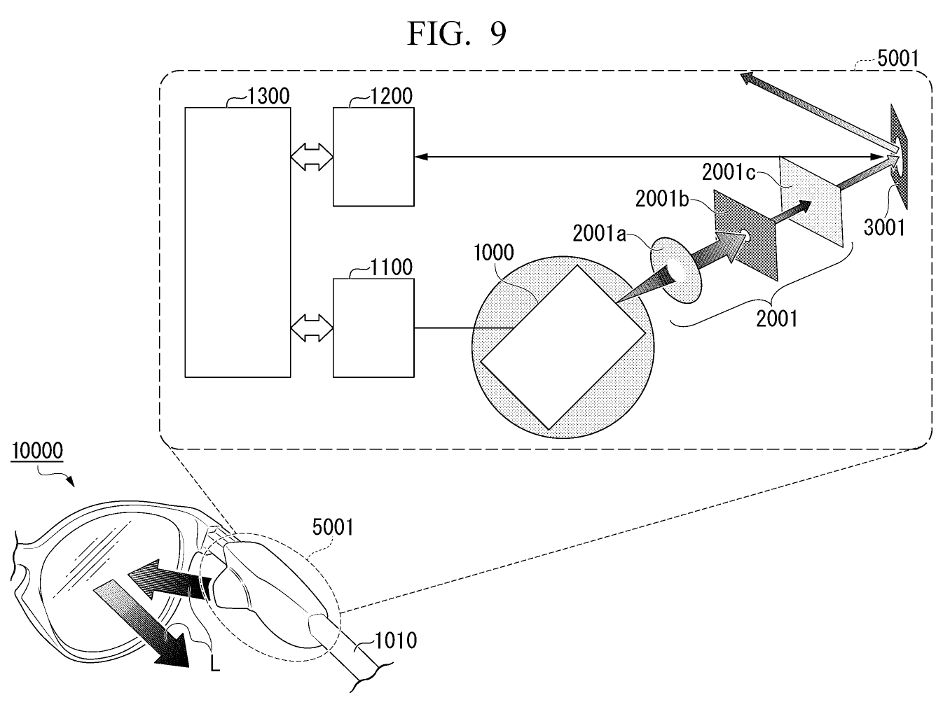

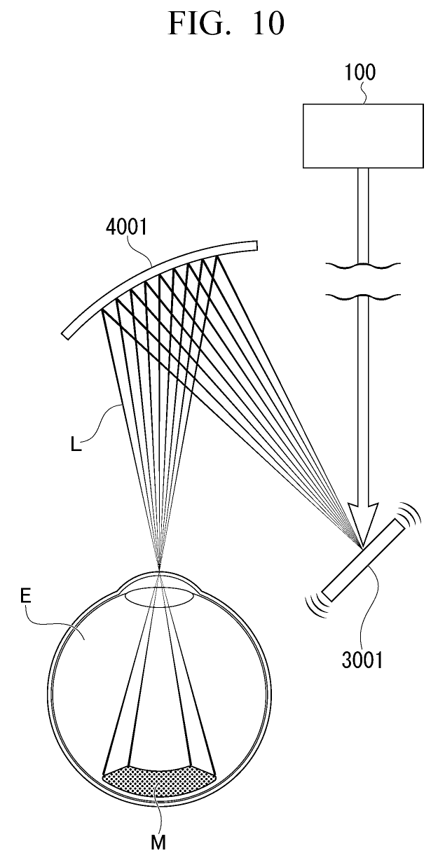

FIG. 9 is an explanatory conceptual view of an example of XR glasses of the present disclosure. FIG. 10 is a conceptual view showing a state where an image is directly projected onto a retina by laser light output from the light source module in the XR glasses shown in FIG. 9. The reference sign L indicates image display light.

XR glasses (eyeglasses) 10000 of the present disclosure are eyeglass-type terminals. “XR” is a collective term for virtual reality (VR), augmented reality (AR), and mixed reality (MR). The reference sign L shown in FIG. 10 indicates image display light.

In the XR glasses 10000 of the present disclosure shown in FIG. 9, the light source module 1000 according to the present disclosure is mounted in an optical engine 5001 installed in a frame 1010. Instead of the light source module 1000, any of the light source modules 1001 to 1003 may be used.

As shown in FIG. 9, the optical engine 5001 includes the light source module 1000, an optical scanning mirror 3001, an optical system 2001 connecting the light source module 1000 and the optical scanning mirror 3001, a laser driver 1100, an optical scanning mirror driver 1200, and a video controller 1300 controlling these drivers.

For example, a MEMS mirror can be used as the optical scanning mirror 3001. In order to project a two-dimensional image, it is preferable to use, as the optical scanning mirror 3001, a two-axis MEMS mirror vibrating so as to reflect laser light while changing an angle thereof in a horizontal direction (X direction) and a vertical direction (Y direction).

The optical system 2001 performs optical processing of laser light output from the light source module 1000. For example, the optical system 2001 including a collimator lens 2001a, a slit 2001b, and an ND filter 2001c can be used. The optical system 2001 shown in FIG. 9 is merely an example, and other configurations may be adopted.

In the XR glasses 10000 of the present disclosure shown in FIG. 9, as shown in FIG. 10, laser light irradiated from the light source module 1000 attached to the frame 1010 is reflected by the optical scanning mirror 3001, further reflected by a lens 4001 of the XR glasses 10000, and enters a human eyeball E as the image display light L, thereby allowing an image (video) to be directly projected onto a retina M.

Since the light source module 1000 of the present disclosure is mounted on the XR glasses 10000 of the present disclosure, electric field efficiency is reduced.

### Industrial Applicability

A light source module of the present disclosure is suitably applicable to optical engines, image display devices, and XR glasses.

### EXPLANATION OF REFERENCES

10 Optical member substrate

30 Laser light source

60 Subcarrier

80 Heat dissipation member

110 Adhesion layer

1000, 1001, 1002, 1003 Light source module

5001 Optical engine module

10000 Image display device (XR glasses)

What is claimed is:

1. A light source module comprising:
a subcarrier;
a plurality of laser light sources installed on an upper surface of the subcarrier;
a heat dissipation member arranged near a lower surface of the subcarrier;
an optical member substrate; and
an optical waveguide arranged on a surface side of the optical member substrate,
wherein the subcarrier and the optical member substrate are arranged such that light output from the laser light sources is input to the optical waveguide, and are integrally coupled with a metal layer therebetween, and
the heat dissipation member and the optical member substrate are integrally coupled.

2. The light source module according to claim 1,
wherein the heat dissipation member is further arranged near a side surface of the subcarrier.

3. The light source module according to claim 2,
wherein a groove for subcarrier is formed on a surface of the heat dissipation member, and the subcarrier is arranged in the groove in a state where the lower surface and the side surface of the subcarrier are surrounded by inner surfaces of the groove.

4. The light source module according to claim 1,
wherein the subcarrier is separately provided for each of the plurality of laser light sources, and the heat dissipation member is a common member shared by the separate subcarriers.

5. The light source module according to claim 1,
wherein the subcarrier is made of aluminum nitride, aluminum oxide, or silicon.

6. The light source module according to claim 1,
wherein the subcarrier and the optical member substrate are eutectically bonded with the metal layer therebetween.

7. The light source module according to claim 1,
wherein the optical member substrate is made of any material selected from the group consisting of a metal material, a ceramic material, and a semiconductor material.

8. The light source module according to claim 1,
wherein the heat dissipation member is made of a ceramic material or a metal material.

9. The light source module according to claim 1,
wherein a gap between the heat dissipation member and the subcarrier is a gap of 50 μm or smaller, or is filled with a metal paste in a solidified state.

10. The light source module according to claim 9,
wherein the metal paste is a silver paste.

11. The light source module according to claim 1,
wherein the heat dissipation member and the optical member substrate are bonded with an adhesion layer therebetween.

12. The light source module according to claim 11,
wherein the adhesion layer is made of a resin material or is made of a resin material and a filler, the resin material is a urethane resin or an epoxy resin, and the filler is silica, alumina, copper, or aluminum.

13. The light source module according to claim 1,
wherein the heat dissipation member and the optical member substrate are individually attached to a common support plate, and the heat dissipation member and the optical member substrate are integrally coupled with the support plate therebetween.

14. The light source module according to claim 1,
wherein all of the plurality of laser light sources are visible-light laser light sources outputting visible light rays.

15. The light source module according to claim 14,
wherein a plurality of the visible light rays are red light, green light, and blue light.

16. An optical engine comprising:
the light source module according to claim 15; and
an optical scanning mirror reflecting, while changing an angle thereof, light output from the light source module so as to display an image.

17. An image display device comprising:
the optical engine according to claim 16 mounted thereon.

18. The image display device according to claim 17,
wherein the image display device is XR glasses.

19. A method for manufacturing the light source module according to claim 1, the method comprising:
a step of coupling the subcarrier and the plurality of laser light sources;
a step of coupling, among the subcarrier and the plurality of laser light sources coupled to each other, the subcarrier and the optical member substrate with a metal layer therebetween; and
a step of coupling the heat dissipation member and the optical member substrate such that a gap of a predetermined distance is provided between the heat dissipation member and the lower surface of the subcarrier.

20. The method for manufacturing the light source module according to claim 19, further comprising:
a step of filling the gap with a metal paste; and
a step of solidifying the metal paste.
